(19) United States
(12) Patent Application Publication
(10) Pub. No.: US 2010/0104940 A1
(43) Pub. Date: Apr. 29, 2010

(54) BATTERY PACK FOR LITHIUM ION BATTERY CELLS

(75) Inventors: Yue-li Wang, GuangDong (CN); Yong Tang, GuangDong (CN); Kai Wu, GuangDong (CN); Wei Chen, GuangDong (CN); Yu-qun Zeng, GuangDong (CN)

Correspondence Address: QUINN LAW GROUP, PLLC, 39555 ORCHARD HILL PLACE, SUITE # 520, NOVI, MI, 48375, US

(73) Assignees: Dongguan Amperex Electronics Technology Limited; Dongguan Amperex Technology Limited

(21) Appl. No.: 12/604,799

(22) Filed: Oct. 23, 2009

(30) Foreign Application Priority Data
Oct. 24, 2008 (CN) CN 200810218614.1

(51) Int. Cl. H01M 2/00

(52) U.S. Cl. 429/163

(57) ABSTRACT

A battery pack configured for lithium ion battery cells includes an inner bonding layer, an intermediate stainless steel layer and an outer protective layer. Due to the arrangement of the intermediate stainless steel layer, the lithium ion battery cell having the battery pack in accordance with the present invention has desirable strength and energy density.

### CROSS-REFERENCE TO RELATED APPLICATIONS

The present patent invention claims priority to Chinese Patent Application No. CN 200810218614.1 filed Oct. 24, 2008, which is incorporated by reference herein in its entirety.

### FIELD OF THE INVENTION

The present invention relates to lithium ion batteries and, more specifically, to a battery pack for lithium ion battery cells.

### BACKGROUND OF THE INVENTION

Lithium ion batteries are widely used as a power source in various portable electronic devices, such as personal laptop computers, mobile phones and personal digital assistants due to high energy density, high working voltage and long life span.

Typically, a conventional battery pack for packing a lithium ion battery cell includes two layers of packing foils, i.e. an inner aluminum foil directly contacting the electrode group and the electrolyte of the lithium ion battery and an outer plastic housing or other packing materials having desirable strength for enclosing the inner aluminum foil, for instance, a thin steel strip or a metal laminate.

Chinese patent application number CN 200720050592.3 discloses a battery pack for lithium ion battery cells as previously discussed. More specifically, the inner aluminum foil directly contacting the electrode group of the lithium ion battery includes three layers of laminates, i.e. an inner polypropylene layer acting as bonding layer, an intermediate aluminum layer and an outer nylon layer acting as protective layer from inside to outside.

However, the aluminum layer does not have strength high enough to protect the electrode group and the electrolyte received therein. To provide the packaged battery cell with desirable strength, there is need to add an additional protective layer.

The above mentioned battery pack do have strength high enough to protect the electrode group and electrolyte received therein. However, the two layers structure of the battery pack will inevitably increase the total volume of the battery cell and reduce the energy density of the lithium ion battery.

### SUMMARY OF THE INVENTION

One objective of the present invention is to provide a battery pack having desirable strength for lithium ion battery cells.

According to one embodiment of the present invention, a battery pack for lithium ion battery cells includes an inner bonding layer, an intermediate stainless steel layer and an outer protective layer.

Preferably, the inner bonding layer is a polypropylene layer.

Preferably, the outer protective layer is a polyester layer.

Preferably, the outer protective layer is a polyethylene terephthalate layer.

Due to the arrangement of the intermediate stainless steel layer, the battery pack for lithium ion battery cells according to one embodiment of the present invention has desirable strength and high energy density and, therefore, there is no need to add an additional protective layer to improve the strength and energy density of the lithium ion battery cell.

Other advantages and novel features will be drawn from the following detailed description of preferred embodiments with the attached drawings, in which:

### BRIEF DESCRIPTION OF THE DRAWINGS

FIG. 1 depicts a diagrammatic laminate structure of a battery pack for lithium ion battery cells according to one embodiment of the present invention;

FIG. 2 depicts a diagrammatic perspective view of a battery cell having the battery pack according to the present invention;

FIG. 3 depicts a diagrammatic cross-sectional view of the battery cell along a line A-A as shown in FIG. 2; and

FIG. 4 depicts an enlarged view of the circled portion IV as shown in FIG. 3.

### DETAILED DESCRIPTION OF THE INVENTION

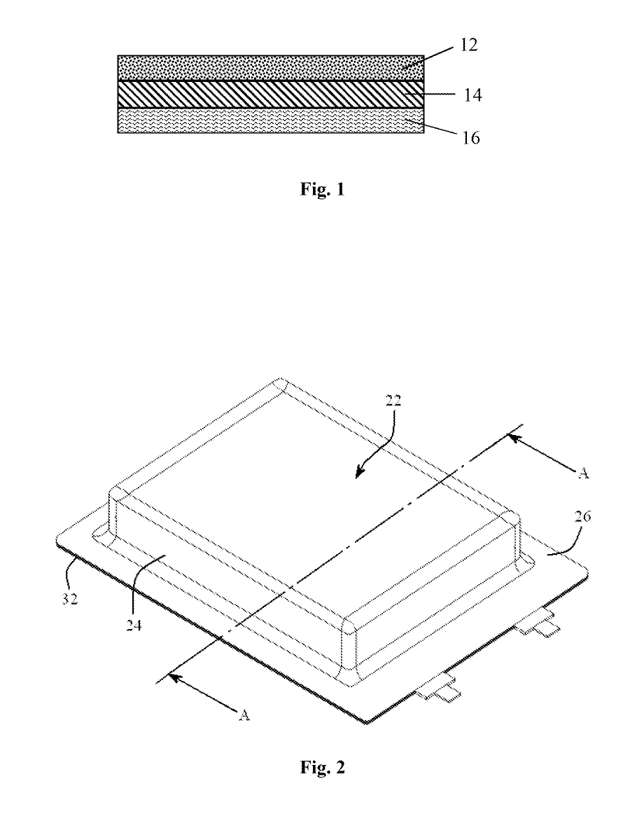

Referring to FIG. 1, from inside to outside, a battery pack 10 for use in lithium ion battery cells in accordance with one embodiment of the present invention includes an inner polypropylene layer 12 acting as the bonding layer, an intermediate stainless steel layer 14 and an outer polyester layer 16 acting as the outer protective layer.

During the packaging of the battery cell, the polypropylene layer 12 directly contacts the electrode group 18 and the electrolyte 20 received therein. The polypropylene layer 12 can be bonded to the electrode group 18 via thermal melting, so as to ensure the stability and sealing effect of the packed battery cell. After being properly packaged, water and air in the environment cannot penetrate into the battery cell and, therefore, the electrode group 18 and the electrolyte 20 are reasonably separated from the environment. The performances of the electrolyte 20 in the lithium ion battery cannot deteriorate easily. It should be noticed that according to an alternative embodiment of the present invention, the inner bonding layer 12 can be made from other bonding materials having characteristics similar to those of polypropylene or the like.

The intermediate stainless steel layer 14 has desirable strength and density, so as to support and protect the electrode group 18 and the electrolyte 20 received therein, as well as prevent the water or the gas in the circumstances from penetrating into the battery cell.

The outer polyester layer 16 is exposed to the outer environment, which can protect the intermediate layer, such as preventing the stainless steel from being oxidized, being eroded or being scratched. In the illustrated embodiment, the polyester layer 16 is polyethylene terephthalate (PET) layer. However, according to an alternative embodiment of the present invention, the outer protective layer can also be made from other materials having similar performances as those of polyethylene terephthalate or the like.

It should be noticed that, the term “electrode group” 18 in the present invention refers to a structure which may include an anode plate and a cathode plate that are wound with a separator disposed therebetween. It should be understood that various modifications can be made to the structure of the battery cell according to different requirements of actual use. Consequently, the description regarding the electrode group 18 in the specification is only intended to explain the concept of the present invention, which will not in any way limit the scope of the present invention.

The lithium ion battery cell having the battery pack 10, in accordance with the embodiment of the present invention, has desirable strength. There is no need to add an additional protective layer to reduce the total volume of the battery cell and improve the energy density thereof. Additionally, due to the arrangement of the intermediate stainless steel layer 14, even though the inner bonding layer is damaged in packaging or in use, the intermediate stainless steel layer 14 still will not react with lithium or lithium ion of the battery cell.

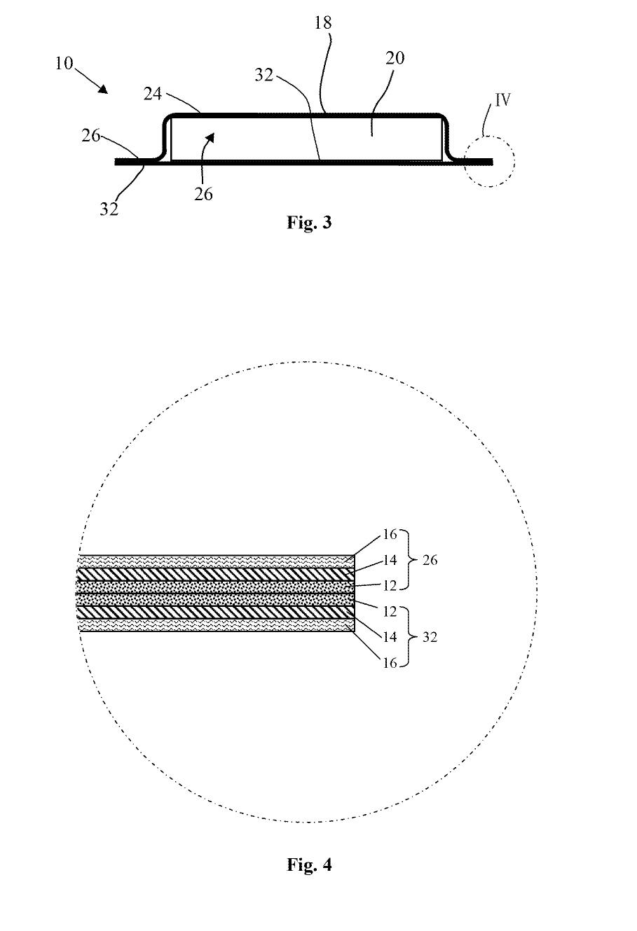

Referring to FIGS. 2 to 4, a packaging case for the lithium ion battery cell having the battery pack 10 according to the present invention includes a receiving housing 22 and a cover 32. The receiving housing 22 is provided with a cubic receiving portion 24 for suitably receiving the electrode group 18 and the electrolyte 20 of the lithium ion battery therein. The receiving portion 24 defines a chamber 26 in a center thereof and a peripheral packing portion 26, i.e., a flange, a lip, and the like, extending outwardly and entirely surrounding the chamber 26. The innermost wall of the receiving portion 24 is a polypropylene layer 12. The outermost wall of the receiving portion 24 is a polyester layer 16. That is, the packing portion 26 has a polypropylene layer 12 facing the cover 32. An outer edge 28 of the packing portion 26 can be mounted on the cover 32.

In the package of the battery cell, the electrode group 18 and the electrolyte 20 are suitably received in the receiving portion 24. The edge 28 of the polypropylene layer 12 of the cover 32 and the polypropylene layer 12 of the peripheral packing portion 26 of the receiving portion 22 are in tight contact with each other and bonded together via thermal melting to seal the chamber 26. It should be appreciated that the bonding of the packing portion 26 to the cover 32 are not limited to thermal melting as any other form of bonding or sealing may be used, as known to those skilled in the art.

It should be understood that, the present invention only set forth one specific manner for packaging the battery cell. However, according to other embodiments of the present invention, the shape of the receiving housing can be adjusted in accordance with different shape of the electrode group and configuration of the elements coupled to the battery cell, so as to receive the electrode group and the electrolyte smoothly.

While the present invention has been illustrated by the above description of the preferred embodiment thereof, while the preferred embodiment has been described in considerable detail, it is not intended to restrict or in any way limit the scope of the appended claims to such details. Additional advantages and modifications within the spirit and scope of the present invention will readily appear to one ordinary skilled in the art. Consequently, the present invention is not limited to the specific details and the illustrative examples shown and described.

1. A battery pack for lithium ion battery cells, comprising:
an inner bonding layer;
an intermediate stainless steel layer; and
an outer protective layer.

2. The battery pack of claim 1, wherein the inner bonding layer is a polypropylene layer.

3. The battery pack of claim 1, wherein the outer protective layer is a polyester layer.

4. The battery pack of claim 1, wherein the outer protective layer is a polyethylene terephthalate layer.

5. A battery pack for lithium ion battery cells comprising:
a receiving housing defining a chamber configured for receiving an electrode group therein peripherally surrounded by a peripheral packing portion;
a cover configured for covering the chamber and including an outer edge configured for tightly contacting the peripheral packing portion to seal the chamber;
wherein each of the receiving housing and the cover are formed from a plurality of layers.

6. The battery pack of claim 5, wherein the plurality of layers include:
an inner bonding layer;
an intermediate stainless steel layer; and
an outer protective layer.

7. The battery pack of claim 6, wherein the inner bonding layer is a polypropylene layer.

8. The battery pack of claim 6, wherein the outer protective layer is a polyester layer.

9. The battery pack of claim 6, wherein the outer protective layer is a polyethylene terephthalate layer.

10. The battery pack of claim 5, wherein the outer edge and the peripheral packing portion are configured for being bonded together via thermal melting.

11. A battery pack for lithium ion battery cells comprising:
a receiving housing defining a chamber peripherally surrounded by a peripheral packing portion;
an electrode group having an electrolyte disposed in the chamber;
a cover covering the chamber and including an outer edge tightly contacting the peripheral packing portion to seal the electrode group and the electrolyte in the chamber;
wherein each of the receiving housing and the cover are formed from a plurality of layers including;
an inner bonding layer;
an intermediate stainless steel layer; and
an outer protective layer.
